(19) United States
(12) Patent Application Publication
(10) Pub. No.: US 2016/0247538 A1
(43) Pub. Date: Aug. 25, 2016

(54) EVENT RECONSTRUCTION SYSTEM AND METHOD THEREOF

(71) Applicant: Industrial Technology Research Institute, Hsinchu (TW)

(72) Inventors: Chun-Fu Chuang, Kaohsiung City (TW); Chun-Che Chang, Changhua County (TW); Chung-Hsien Yang, Taipei City (TW); Yin-Chih Lu, Hsinchu County (TW); Ming-Hsuan Cheng, Hsinchu City (TW)

(21) Appl. No.: 14/693,883

(22) Filed: Apr. 23, 2015

(30) Foreign Application Priority Data
Feb. 25, 2015 (TW) 104106035

(51) Int. Cl. G11B 27/10; H04N 5/91; G11B 27/031

(52) U.S. Cl. CPC G11B 27/10; G11B 27/031; H04N 5/91

(57) ABSTRACT

The present disclosure provides an event reconstruction system including a communication unit, a key information integration device, a storage unit and a computation unit. The key information integration device receives key information from a plurality of image capturing device through the communication unit. The key information includes a first identification code and a second identification code retrieved from a first image capturing device and a second image capturing device respectively. The storage unit stores the key information. The computation unit extracts the key information and confirms the second image capturing device transmitting the second identification code according to the first identification code and the second identification code in the key information. The key information integration device sends a retrieving request to the second image capturing device through the communication unit and receives a video file corresponding to the second identification code from the second image capturing device.

### CROSS-REFERENCE TO RELATED APPLICATION

This application claims the priority benefit of Taiwan application serial no. 104106035, filed on Feb. 25, 2015. The entirety of the above-mentioned patent application is hereby incorporated by reference herein and made a part of this specification.

### TECHNICAL FIELD

The disclosure relates to an event reconstruction system capable of reconstructing an accident scene and obtaining key evidences and a method thereof.

### BACKGROUND

In recent years, along with development of image capturing and recording technology, driving recorders are widely used. Although the driving recorders can assist clarifying the cause of an accident and restoring the truth of the accident to serve as an evidence of proof when the accident is occurred, it is not guaranteed that the driving recorder photographs the accident from a most clear angle.

The conventional driving recorder emphasizes self protection, though it has many blind angles, and it is not guaranteed to photograph all of the reasons causing the accident, so that when the accident occurs, it may be difficult to find the evidence of the accident, for example, accidents occurred at the blind angles of the driving recorder such as a false car accident, a collision with the vehicle in the front, suffering a side impact, etc. However, a key video is probably happened to be captured by a passer-by, though the passer-by himself does not know that he has captured the key evidence of the accident, and the key video is erased or overwritten as time goes by. These seemingly useless videos for the passers-by are probably key evidences of the accident, so that it is an issue to be resolved to make a use of these videos that are capable of providing key evidences but are usually erased inadvertently.

### SUMMARY

The disclosure is directed to an event reconstruction system and a method thereof, which is capable of marking an event when the event is occurred and notifying devices having an image capturing function nearby to retain video files associated with the event, such that both sides of the event are able to retrieve and inspect the video files to restore the original event.

An exemplary embodiment of the disclosure provides an event reconstruction system including a communication unit, a key information integration device, a storage unit and a computation unit. The key information integration device receives key information corresponding to an event from a plurality of image capturing devices through the communication unit, where the key information includes a first identification code and a second identification code, and the first identification code is retrieved from a first image capturing device among the image capturing devices and the second identification code is retrieved from a second image capturing device among the image capturing devices. The storage unit stores the key information. The computation unit analyses the key information corresponding to the event and confirms the second image capturing device transmitting the second identification code according to the first identification code and the second identification code in the key information. The key information integration device sends a retrieving request to the second image capturing device transmitting the second identification code through the communication unit and receives a video file corresponding to the second identification code from the second image capturing device.

An exemplary embodiment of the disclosure provides an event reconstruction system including a sensing unit, a storage unit, a computation unit and a communication unit. The sensing unit captures driving sensing data. The storage unit stores original image data in the driving sensing data. The computation unit determines occurrence of an event according to the driving sensing data and generates a first identification code. The communication unit transmits the first identification code to a key information integration device.

An exemplary embodiment of the disclosure provides an event reconstruction method. The method includes receiving key information corresponding to an event from a plurality of image capturing devices and storing the key information, where the key information includes a first identification code and a second identification code, and the first identification code is retrieved from a first image capturing device among the image capturing devices and the second identification code is retrieved from a second image capturing device among the image capturing devices. The method also includes analysing the key information corresponding to the event, and confirming the second image capturing device transmitting the second identification code according to the first identification code and the second identification code in the key information. The method further includes sending a retrieving request to the second image capturing device transmitting the second identification code, and receiving a video file corresponding to the second identification code from the second image capturing device.

An exemplary embodiment of the disclosure provides an event reconstruction method. The method includes capturing driving sensing data; and storing original image data in the driving sensing data. The method also includes determining occurrence of an event according to the driving sensing data, and generating a first identification code. The method further includes transmitting the first identification code to a key information integration device.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram of an event reconstruction system according to an exemplary embodiment of the disclosure.

FIG. 2 is a schematic diagram of fields included in a first identification code according to an exemplary embodiment of the disclosure.

FIG. 3A and FIG. 3B are schematic diagrams of an event reconstruction method according to an exemplary embodiment of the disclosure.

FIG. 4A-FIG. 4C are flowcharts illustrating an event reconstruction method according to an exemplary embodiment of the disclosure.

### DETAILED DESCRIPTION OF DISCLOSED EMBODIMENTS

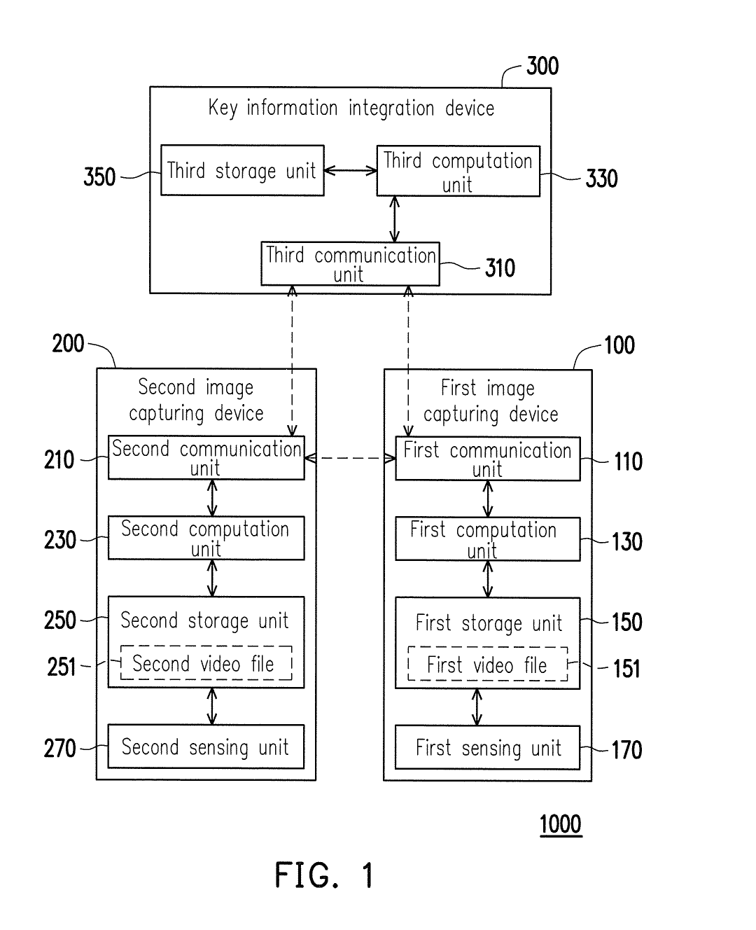

FIG. 1 is a block diagram of an event reconstruction system according to an exemplary embodiment of the disclosure.

Referring to FIG. 1, the event reconstruction system 1000 includes a first image capturing device 100, a second image capturing device 200 and a key information integration device 300.

The first image capturing device 100 may be a driving recorder disposed on a vehicle, which is used for recording driving images of the vehicle. The second image capturing device 200 may be a driving recorder disposed on a vehicle, a camera monitor disposed on roadside, or other electronic device having an image capturing function. In the present exemplary embodiment, the second image capturing device 200 is located adjacent to the first image capturing device 100, and records driving images of the vehicle or monitoring images of the camera monitor.

In the present exemplary embodiment, the first image capturing device 100, for example, includes a first communication unit 110, a first computation unit 130, a first storage unit 150 and a first sensing unit 170. The second image capturing device 200 includes a second communication unit 210, a second computation unit 230, a second storage unit 250 and a second sensing unit 270.

The first communication unit 110 and the second communication unit 210 may be communication chips supporting one of a global system for mobile communication (GSM) system, a personal handy-phone system (PHS), a code division multiple access (CDMA) system, a wireless fidelity (WiFi) system, a worldwide interoperability for microwave access (WiMAX) system, a third generation (3G) wireless communication technique, a long term evolution (LTE) technique, etc., or a combination thereof.

The first computation unit 130 and the second computation unit 230 may be central processing units (CPUs), microprocessors, application specific integrated circuits (ASICs), programmable logic device (PLDs) or other similar devices.

The first storage unit 150 and the second storage unit 250 may be memory devices such as secure digital (SD) cards, multimedia memory cards (MMCs), memory sticks (MSs), compact flash (CF) cards, embedded MMC (eMMC) cards or solid state disk (SSD), etc.

The first sensing unit 170 and the second sensing unit 270 may include image sensors capable of identifying event occurrence according to images or vibration sensors capable of identifying event occurrence through a vibration strength or a collision strength, or other sensors capable of identifying the event occurrence.

The key information integration device 300 is, for example, a cloud server, which has a function of processing and storing a large amount of data, and may communicate with the first image capturing device 100 and the second image capturing device 200 though a wired or wireless network. In the present exemplary embodiment, the key information integration device 300 includes a third communication unit 310, a third computation unit 330 and a third storage unit 350.

For example, the third communication unit 310 is a communication chip having a wireless and/or wired communication function, and the third computation unit 330 is a single or a series of central processors of a general desktop computer or a central processor of a server with a powerful multiplexing effect (for example, a central processor of Intel Xeon series or a central processor of AMD Opteron series), and the third storage unit 350 is a disk array having a mass data storage function and a data protection function.

In the present exemplary embodiment, the image sensor of the first sensing unit 170 and the image sensor of the second sensing unit 270 in the first image capturing device 100 and the second image capturing device 200 respectively and continually capture a first video file 151 and a second video file 251, and respectively store the first video file 151 and the second video file 251 to the first storage unit 150 and the second storage unit 250.

Particularly, when the vehicle that carries the first image capturing device 100 has an accident, for example, has a collision, a car accident or is turned upside down due to a road factor, etc., the first sensing unit 170 transmits driving sensing data to the first computation unit 130, and the first computation unit 130 determines occurrence of the accident according to the driving sensing data, and generates a first identification code.

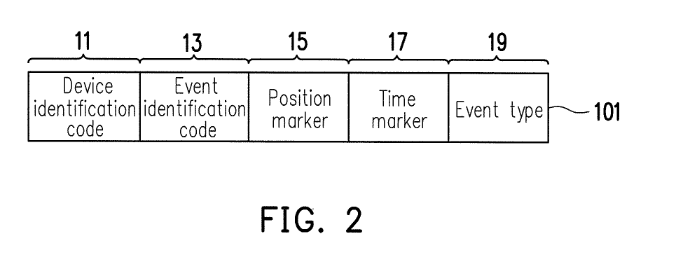

FIG. 2 is a schematic diagram of fields included in the first identification code according to an exemplary embodiment of the disclosure.

Referring to FIG. 2, the first identification code 101, for example, includes one of an electronic device identification code (device identification code) 11, an event identification code 13, a position marker 15, a time marker 17, an event type 19, or any combination of two or more of selected from the above. The device identification code 11 is an entry code of the first image capturing device 100 in the event reconstruction system 1000. The event identification code 130 is an entry code of the first image capturing device 100 having the accident. Since the first identification code 101 is generated by the first image capturing device 100 having the accident, in the first identification code 101, the device identification code is the same to the event identification code 13. The position marker 15 records a position of the accident, which is represented by longitude and latitude. The time marker 17 records a time of the accident. The event type 19 records the type of the accident, for example, collision. It should be noticed that the first image capturing device 100 may further include a positioning function, for example, includes a positioning unit having a global positioning system (GPS) function. When the first computation unit 130 generates the first identification code 101, the first computation unit 130 obtains current coordinates of the first image capturing device 100 from the positioning unit, and fills the coordinates in the position marker 15 of the first identification code 101.

Referring to FIG. 1 again, when the first computation unit 130 of the first image capturing device 100 determines that the accident is occurred according to the driving sensing data, the first computation unit 130 generates the first identification code 101. Particularly, the first computation unit 130 transmits the generated first identification code 101 to the key information integration device 300 through the first communication unit 110, and broadcasts the first identification code 101 through the first communication unit 110. Moreover, the first computation unit 130 sets a part of the first video file 151 to a retention state according to the time marker 15 in the first identification code 101, such that this part of the video file 151 cannot be erased or overwritten within a short period of time.

In the present exemplary embodiment, since the second image capturing device 200 is located adjacent to the first image capturing device 100, the second image capturing device 200 may receive the first identification code 101 broadcasted by the first image capturing device 100. Particularly, after receiving the first identification code 101 broadcasted by the first image capturing device 100, the second computation unit 230 generates a second identification code according to the first identification code 101.

For example, the second identification code has the same fields as that of the first identification code 101, i.e. the second identification code also includes one of the device identification code 11, the event identification code 13, the position marker 15, the time marker 17, the event type 19, or any combination of two or more of selected from the above. After receiving the first identification code 101 broadcasted by the first image capturing device 100, the second computation unit 230 modifies the device identification code 11 in the first identification code 101 to an entry code of the second image capturing device 200, so as to generate the second identification code. It should be noticed that, the second image capturing device 200 further includes a positioning unit having a positioning function, for example, the GPS function. When the second computation unit 230 generates the second identification code, the second computation unit 230 obtains current coordinates of the second image capturing device from the positioning unit, and fills the coordinates in the position marker 15 of the second identification code.

After the second computation unit 230 generates the second identification code, the second computation unit 230 transmits the second identification code to the third storage unit 350 of the key information integration device 300 through the second communication unit 210. Meanwhile, the second image capturing device 200 sets a part of the second video file 251 to the retention state according to the time marker 15 in the second identification code, such that this part of the video file 251 cannot be erased or overwritten within a short period of time.

After the accident is occurred, the user of the first image capturing device 100 may send an event image request to the key information integration device 300 through the first image capturing device 100 or other terminals. For example, the user can log in the key information integration device 300 by inputting the device identification code 11 (and a corresponding password) of the first identification code 101 to sent an image request. The key information integration device 300 searches the first identification code 101 and the second identification code in the third storage unit 350 according to the device identification code 11 input by the user after receiving the image request, and sends the image request to the first image capturing device 100 and the second image capturing device 200. When the first image capturing device 100 and the second image capturing device 200 receive the image request, the first image capturing device 100 and the second image capturing device 200 respectively retrieve a part of the first video file 151 and a part of the second video file 251 corresponding to the first identification code 101 and the second identification code from the first storage unit 150 and the second storage unit 250, and store the part of the first video file 151 and the part of the second video file 251 to the third storage unit 350 for the user to retrieve. For example, after the part of the first video file 151 and the part of the second video file 251 corresponding to the first identification code 101 and the second identification code in the first storage unit 150 and the second storage unit 250 are transmitted to the key information integration device 300, the retention state of the part of the first video file 151 and the part of the second video file 251 can be released.

It should be noticed that in the above description, although the key information integration device 300 obtains the part of the first video file 151 and the part of the second video file 251 from the first image capturing device 100 and the second image capturing device 200 only after receiving the image request from the user, the disclosure is not limited thereto. The first image capturing device 100 and the second image capturing device 200 may also directly transmit the part of the first video file 151 and the part of the second video file 251 corresponding to the first identification code 101 and the second identification code to the key information integration device 300 after generating the first identification code 101 and the second identification code. In this way, the key information integration device 300 may directly provide the part of the first video file 151 and the part of the second video file 251 in the third storage unit 350 to the user after receiving the image request from the user.

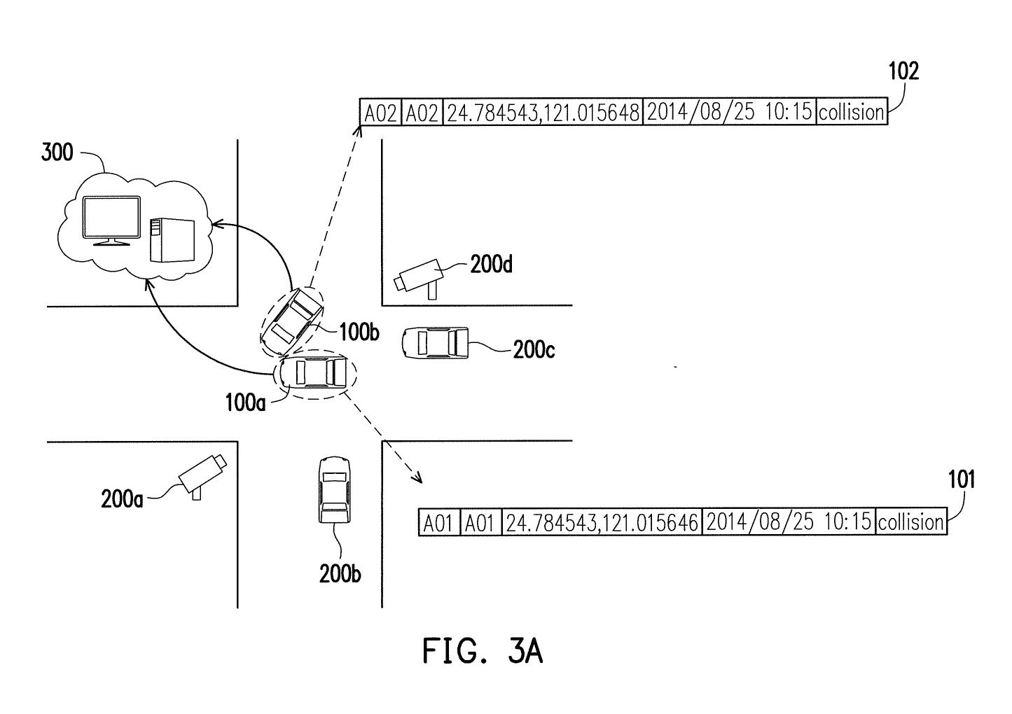

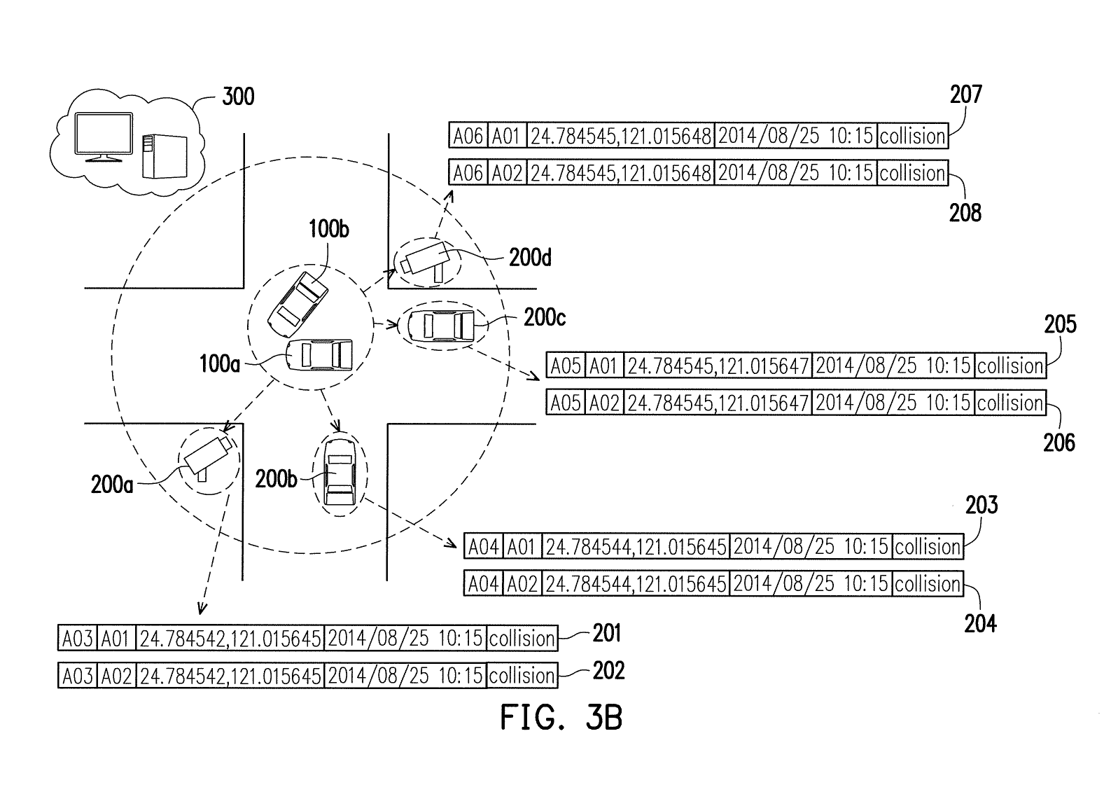

FIG. 3A and FIG. 3B are schematic diagrams of an event reconstruction method according to an exemplary embodiment of the disclosure.

For simplicity's sake, the following first image capturing device 100a and 100b may also represent vehicles where the first image capturing devices 100a and 100b are located. The second image capturing devices 200a, 200b, 200c and 200d may also represent vehicles where the second image capturing devices 200a, 200b, 200c and 200d are located or devices having a camera function such as roadside monitors, etc.

Referring to FIG. 3A, when the first image capturing device 100a and the first image capturing device 100b produce an accident, the first image capturing device 100a and the first image capturing device 100b may respectively generate a first identification code 101 and a first identification code 102, where ‘A01’ is an entry code of the first image capturing device 100a in the key information integration device 300 and ‘A02’ is an entry code of the first image capturing device 100b in the key information integration device 300.

It should be noticed that since the first identification code 101 and the second identification code 102 are respectively generated by the first image capturing device 100a and the first image capturing device 100b having the accident, the device identification codes 11 are the same as the event identification codes 13 in the first identification code 101 and the second identification code 102. After generating the first identification code 101 and the first identification code 102, the first image capturing device 100a and the first image capturing device 100b respectively transmit the respective first identification code 101 and first identification code 102 to the key information integration device 300, and set a part of the first video file 151 and a part of the second video file 251 corresponding to the time marker 17 that are continually captured by the first image capturing device 100a and the first image capturing device 100b to the retention state according to the time markers 17 in the first identification code 101 and the first identification code 102.

Referring to FIG. 3B, after the first image capturing devices 100a and 100b transmit the respective first identification code 101 and the first identification code 102 to the key information integration device 300, the first image capturing devices 100a and 100b broadcast the first identification code 101 and the first identification code 102 to the neighbouring second image capturing devices 200a, 200b, 200c and 200d. When the second image capturing devices 200a, 200b, 200c and 200d receive the first identification code 101 and the first identification code 102, the second image capturing device 200a generates corresponding second identification code 201 and second identification code 202, the second image capturing device 200b generates corresponding second identification code 203 and second identification code 204, the second image capturing device 200c generates corresponding second identification code 205 and second identification code 206, and the second image capturing device 200d generates corresponding second identification code 207 and second identification code 208. ‘A03’, ‘A04’, ‘A05’ and ‘A06’ are respectively entry codes of the second image capturing devices 200a, 200b, 200c and 200d in the key information integration device 300.

It should be noticed that except for broadcasting the first identification code 101 and the first identification code 102 to the neighbouring second image capturing devices 200a, 200b, 200c and 200d by the first image capturing devices 100a and 100b through short-distance communication, the first image capturing devices 100a and 100b may also transmit the first identification code 101 and the first identification code 102 to the key information integration device 300, and the key information integration device 300 transmits the first identification code 101 and the first identification code 102 to the second image capturing devices 200a, 200b, 200c and 200d neighbouring to the first image capturing devices 100a and 100b according to the position markers 15 in the first identification code 101 and the first identification code 102.

After the second image capturing devices 200a, 200b, 200c and 200d generate the second identification codes 201-208, the second image capturing devices 200a, 200b, 200c and 200d transmit the respective second identification codes 201-208 to the key information integration device 300, and set a part of video corresponding to the time marker 15 that are continually captured by the second image capturing devices 200a, 200b, 200c and 200d to the retention state according to the time markers 15 in the second identification codes 201-208.

Finally, when the user of the first image capturing device 100a wants to obtain an evidence video of the accident, the user may send an event image request to the key information integration device 300. For example, the user may log in the key information integration device 300 to sent the image request by inputting the device identification code A01 (and the corresponding password) of the first image capturing device 100a. The key information integration device 300 receives the image request and searches the first identification code 101 and the second identification codes 201, 203, 205 and 207 with the event identification codes 13 of A01, and sends the image request to the first image capturing device 100a and the second image capturing devices 200a, 200b, 200c and 200d. When the first image capturing device 100a and the second image capturing devices 200a, 200b, 200c and 200d receive the image request, the first image capturing device 100a and the second image capturing devices 200a, 200b, 200c and 200d obtain the video files corresponding to the time marker 15, and transmit the same to the key information integration device 300 for the user to retrieve.

It should be noticed that in the aforementioned description, although the key information integration device 300 obtains the video files corresponding to the time marker from the first image capturing device 100a and the second image capturing devices 200a, 200b, 200c and 200d only after receiving the image request from the user, the disclosure is not limited thereto. The first image capturing device 100a and the second image capturing devices 200a, 200b, 200c and 200d may also directly transmit the video files corresponding to the time markers 15 of the first identification codes 101, 102 and the second identification codes 201-208 to the key information integration device 300 after generating the first identification code and the second identification code. In this way, the key information integration device 300 may directly provide the video files to the user after receiving the image request from the user.

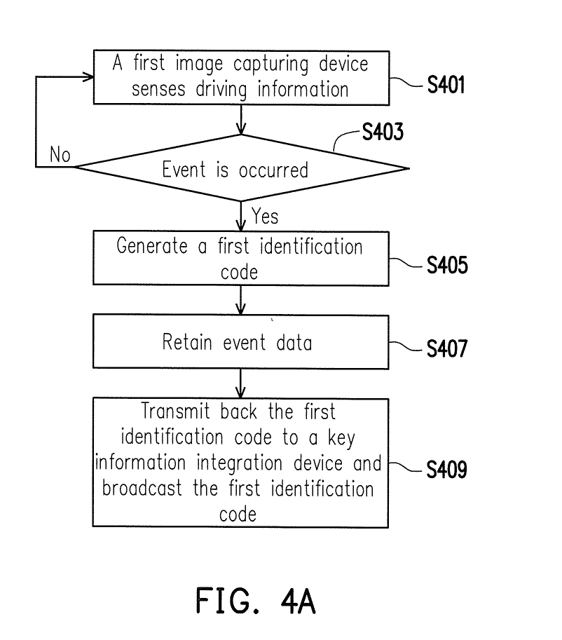

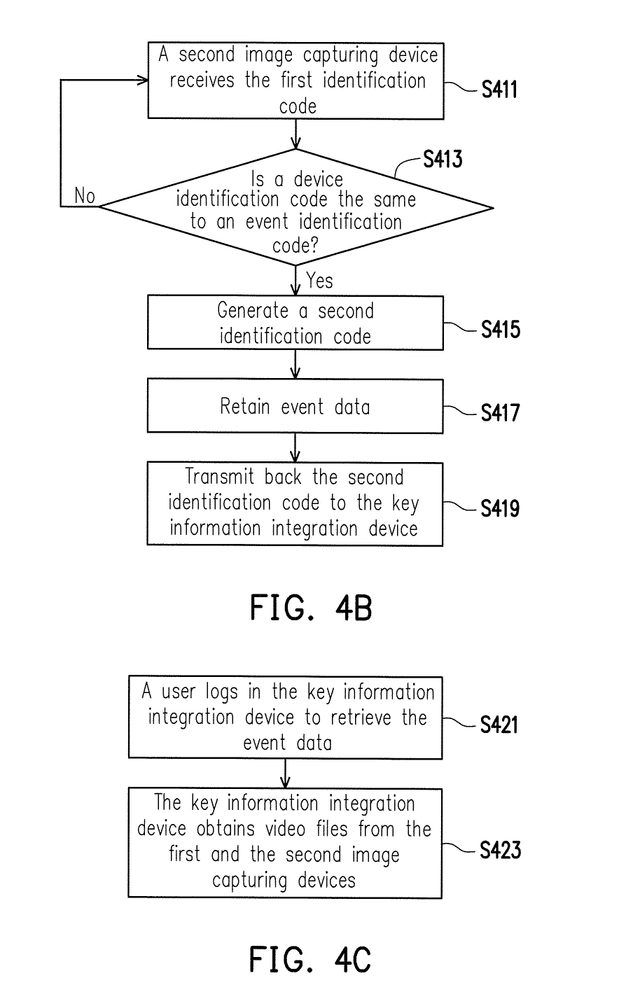

FIG. 4A, FIG. 4B and FIG. 4C are flowcharts illustrating an event reconstruction method according to an exemplary embodiment of the disclosure.

Referring to FIG. 4A, in step S401, the image sensor of the first sensing unit 170 of the first image capturing device 100 keeps recording the first video file 151 and stores the first video file 151 in the first storage unit 150.

In step S430, the first computation unit 130 of the first image capturing device 100 determines whether an accident is occurred according to a collision sensor of the first sensing unit 170.

If the first sensing unit 170 senses occurrence of the accident, step S405 is executed, and if non accident is occurred, the flow returns to step S401.

In step S405, the first computation unit 130 records a device identification code, an event identification code, a position marker, a time marker and an event type of the accident to generate a first identification code. In step S407, the first computation unit 130 retains a part of the first video file 151 according to the time marker in the first identification code. Then, in step S409, the first image capturing device 100 transmits the first identification code to the key information integration device 300 and broadcasts the first identification code to the nearby electronic devices.

Referring to FIG. 4B, in step S411, the second image capturing device 200 receives the first identification code. After the second image capturing device 200 receives the first identification code, in step S413, the second computation unit 230 determines whether the device identification code of the first identification code is the same to the event identification code thereof, and if yes, step S415 is executed, and if not, the flow returns back to step S411 to continually wait for receiving the first identification code. In step S415, the second computation unit 230 generates a second identification code according to the first identification code. Particularly, the second computation unit 230 modifies the device identification code in the first identification code to an entry code of the second image capturing device 200, so as to generate the second identification code. In step S417, the second computation unit 230 retains a part of the second video file 251 according to the time marker in the second identification code. In step S419, the second image capturing device 200 transmits the second identification code to the key information integration device 300.

Referring to FIG. 4C, in step S421, the user logs in the key information integration device 300 by inputting the device identification code and the corresponding password, and sends an image request. After the key information integration device 300 receives the image request, in step S423, the key information integration device 300 obtains a part of the first video file 151 and a part of the second video file 251 corresponding to the first identification code and the second identification code from the first image capturing device 100 and the second image capturing device 200 for the user to retrieve.

In summary, the disclosure provides the event reconstruction system and the event reconstruction method, when an electronic device on a vehicle detects occurrence of an accident, the electronic device generates an identification code to mark the accident, and broadcasts the identification code to the nearby vehicles or the roadside camera devices, such that the video captured by the nearby vehicles or the roadside camera devices are also retained and uploaded to a cloud platform for both sides of the accident to retrieve after the accident. In this way, the reconstruction of the accident is implemented, and storage spaces of the vehicle electronic device and the cloud platform are effectively used.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An event reconstruction system, comprising:
a communication unit;
a key information integration device, receiving key information corresponding to an event from a plurality of image capturing devices through the communication unit, wherein the key information comprises a first identification code and a second identification code, and the first identification code is retrieved from a first image capturing device of the image capturing devices and the second identification code is retrieved from a second image capturing device of the image capturing devices;
a storage unit, storing the key information; and
a computation unit, analysing the key information corresponding to the event and confirming the second image capturing device transmitting the second identification code according to the first identification code and the second identification code in the key information,
wherein the key information integration device sends a retrieving request to the second image capturing device transmitting the second identification code through the communication unit and receives a video file corresponding to the second identification code from the second image capturing device.

2. The event reconstruction system as claimed in claim 1, wherein the computation unit confirms the first image capturing device transmitting the first identification code according to the first identification code.

3. The event reconstruction system as claimed in claim 2, wherein the key information integration device sends the retrieving request to the first image capturing device transmitting the first identification code through the communication unit, and receives a video file corresponding to the first identification code from the first image capturing device.

4. The event reconstruction system as claimed in claim 1, wherein the first identification code comprises at least one of an electronic device identification code, an event identification code, a position marker, a time marker, an event type, or any combination of two or more of selected from the above.

5. An event reconstruction system, comprising:
a sensing unit, capturing driving sensing data;
a storage unit, storing original image data in the driving sensing data;
a computation unit, determining occurrence of an event according to the driving sensing data and generating a first identification code; and
a communication unit, transmitting the first identification code to a key information integration device.

6. The event reconstruction system as claimed in claim 5, wherein the computation unit retains a video file corresponding to the first identification code in the original image data according to the first identification code.

7. The event reconstruction system as claimed in claim 6, wherein the communication unit receives a retrieving request from the key information integration device and transmits the video file corresponding to the first identification code to the key information integration device.

8. The event reconstruction system as claimed in claim 5, wherein the communication unit receives the first identification code, and the computation unit generates a second identification code according to the first identification code.

9. The event reconstruction system as claimed in claim 8, wherein the communication unit transmits the second identification code to the key information integration device.

10. The event reconstruction system as claimed in claim 8, wherein the computation unit retains a video file corresponding to the second identification code in the original image data according to the second identification code.

11. The event reconstruction system as claimed in claim 10, wherein the communication unit receives a retrieving request from the key information integration device and transmits the video file corresponding to the second identification code to the key information integration device.

12. The event reconstruction system as claimed in claim 5, wherein the first identification code comprises at least one of an electronic device identification code, an event identification code, a position marker, a time marker, an event type, or any combination of two or more of selected from the above.

13. An event reconstruction method, comprising:
receiving key information corresponding to an event from a plurality of image capturing devices, wherein the key information comprises a first identification code and a second identification code, and the first identification code is retrieved from a first image capturing device of the image capturing devices and the second identification code is retrieved from a second image capturing device of the image capturing devices;
storing the key information;
analysing the key information corresponding to the event, and confirming the second image capturing device transmitting the second identification code according to the first identification code and the second identification code in the key information; and
sending a retrieving request to the second image capturing device transmitting the second identification code, and receiving a video file corresponding to the second identification code from the second image capturing device.

14. The event reconstruction method as claimed in claim 13, further comprising:
confirming the first image capturing device transmitting the first identification code according to the first identification code.

15. The event reconstruction method as claimed in claim 14, further comprising:
sending the retrieving request to the first image capturing device transmitting the first identification code, and receiving a video file corresponding to the first identification code from the first image capturing device.

16. The event reconstruction method as claimed in claim 13, wherein the first identification code comprises at least one of an electronic device identification code, an event identification code, a position marker, a time marker, an event type, or any combination of two or more of selected from the above.

17. An event reconstruction method, comprising:
capturing driving sensing data;
storing original image data in the driving sensing data;
determining occurrence of an event according to the driving sensing data, and generating a first identification code; and
transmitting the first identification code to a key information integration device.

18. The event reconstruction method as claimed in claim 17, further comprising:
retaining a video file corresponding to the first identification code in the original image data according to the first identification code.

19. The event reconstruction method as claimed in claim 18, further comprising:
receiving a retrieving request from the key information integration device and transmitting the video file corresponding to the first identification code to the key information integration device.

20. The event reconstruction method as claimed in claim 17, further comprising:
receiving the first identification code, and generating a second identification code according to the first identification code.

21. The event reconstruction method as claimed in claim 20, further comprising:
transmitting the second identification code to the key information integration device.

22. The event reconstruction method as claimed in claim 20, further comprising:
retaining a video file corresponding to the second identification code in the original image data according to the second identification code.

23. The event reconstruction method as claimed in claim 22, further comprising:
receiving a retrieving request of the key information integration device and transmitting the video file corresponding to the second identification code to the key information integration device.

24. The event reconstruction method as claimed in claim 17, wherein the first identification code comprises at least one of an electronic device identification code, an event identification code, a position marker, a time marker, an event type, or any combination of two or more of selected from the above.
